(19) United States
(12) Patent Application Publication
(10) Pub. No.: US 2026/0181018 A1
(43) Pub. Date: Jun. 25, 2026

(54) SYSTEMS AND METHODS FOR UPDATING A DATABASE WITH INFORMATION ABOUT PHISHING RESOURCES

(71) Applicant: AO Kaspersky Lab, Moscow (RU)

(72) Inventors: Alexey S. Marchenko, Moscow (RU); Mikhail S. Kozlov, Moscow (RU); Alexey E. Utki-Otki, Moscow (RU); Dmitry S. Golubev, Moscow (RU); Yuri G. Slobodyanuk, Moscow (RU); Egor A. Bubnov, Moscow (RU); Mikhail A. Sytnik, Moscow (RU)

(21) Appl. No.: 19/420,932

(22) Filed: Dec. 16, 2025

(30) Foreign Application Priority Data
Dec. 19, 2024 (RU) 2024138550

(51) Int. Cl. H04L 9/40; G06F 16/23

(52) U.S. Cl. CPC H04L 63/1483; G06F 16/2379

(57) ABSTRACT

A system generates a temporal model for a phishing resource from the database. The system evaluates the phishing resource based on the temporal model. The system determines that the phishing resource is non-phishing based on evaluation results generated during the evaluating. The system updates information about the phishing resource in the database.

### CROSS-REFERENCE TO RELATED APPLICATIONS

This application claims the benefit of Russian Patent Application No. 2024138550, filed Dec. 19, 2024, which is herein incorporated by reference.

### FIELD OF TECHNOLOGY

The present disclosure relates to the field of information technology, and, more specifically, to systems and methods for updating stored information about phishing resources in databases.

### BACKGROUND

With the rapid development of computer networks and network technologies for storing and transmitting information, for example the Internet, data have become a valuable digital asset. Fraudsters, recognizing their value, use various methods to obtain user data, such as social network login credentials, banking details, etc. One of the most popular methods for obtaining unauthorized access to user data is phishing. In light of this threat, it is extremely important to protect user data from fraudsters.

Many different methods for detecting phishing resources are known from the prior art, but most share the approach that a detected phishing resource is added to an anti-phishing database. An anti-phishing database is a database including information about phishing resources, such as web addresses. Thanks to the use of anti-phishing databases, there is no need to perform deep analysis of a resource every time a user attempts to access it, since a quick check can be performed using the database. However, the use of anti-phishing databases introduces other problems. Over time, anti-phishing databases occupy increasingly large amounts of memory, while the lifetime of most phishing resources is short and may be measured in one or two days.

It is also worth noting that when legitimate resources are compromised, for example a web page of a banking organization, the anti-phishing system will add a record corresponding to that resource to the anti-phishing database, as a result of which the user will be unable to visit that web page. However, after the phishing content is removed from the web page, for example a form for collecting user data disguised as the login form of the banking organization's resource, the user will still be unable to visit that web page, because the record corresponding to that resource was saved in the anti-phishing database. Consequently, the use of anti-phishing databases as described above leads to false positives by anti-phishing systems.

Therefore, there is a need to develop a solution that allows updating the information stored in an anti-phishing database. At the same time, in order to save computational resources, the solution should update the anti-phishing database in the most efficient way.

### SUMMARY

The claimed technical solution proposes a new approach to updating a database including information about phishing resources. This solution uses an approach that makes it possible to significantly reduce the number of evaluations performed on phishing resources from the anti-phishing database, in order to maintain a specified ratio of the number of outdated records (information) in the anti-phishing database to the size of the database. Thus, the technical problem of improving the efficiency of database updating is solved.

The technical result is a reduction in false positives of an anti-phishing system that uses a database including information about phishing resources, by disabling records that no longer relate to phishing resources. Another technical result achieved in solving this problem is improving the efficiency of updating a database including information about phishing resources by reducing the number of evaluations for each phishing resource whose record is stored in said database. These technical results may be achieved by implementing a system and method for updating a database including information about phishing resources.

In one exemplary aspect, the techniques described herein relate to a method for updating a database including information about phishing resources, including: generating a temporal model for a phishing resource from the database; evaluating the phishing resource based on the temporal model; determining that the phishing resource is non-phishing based on evaluation results generated during the evaluating; and updating information about the phishing resource in the database.

In some aspects, the techniques described herein relate to a method, wherein the temporal model includes an evaluation phase and an evaluation period.

In some aspects, the techniques described herein relate to a method, wherein the evaluation period is calculated for each evaluation phase based on an ordinal number of the evaluation phase and a phase coefficient, wherein the phase coefficient is a predefined number.

In some aspects, the techniques described herein relate to a method, wherein the temporal model additionally includes a trust counter, initially equal to zero and incremented each time the phishing resource is determined to be non-phishing based on the evaluation results.

In some aspects, the techniques described herein relate to a method, wherein the information about the phishing resource is updated in the database when the trust counter equals a threshold value, wherein the threshold value is a predefined integer.

In some aspects, the techniques described herein relate to a method, wherein the information about the phishing resource further includes one or more of: a web address pointing to the phishing resource; a date a record about the phishing resource was added to the database; and a status of the record about the phishing resource.

In some aspects, the techniques described herein relate to a method, wherein the information about the phishing resource additionally includes a hash of a web page of the phishing resource.

In some aspects, the techniques described herein relate to a method, wherein evaluating the phishing resource includes checking for changes to the web page based on comparing hashes.

In some aspects, the techniques described herein relate to a method, wherein evaluating the phishing resource is carried out according to the temporal model based on at least one of: a machine learning model trained to solve a classification task based on content information and/or meta information about the phishing resource; analysis of HTML code of the phishing resource converted into a tree.

In some aspects, the techniques described herein relate to a method, wherein the content information about the phishing resource is at least one of: the HTML code of the phishing resource; Flash applications or Java applets loaded from the phishing resource, multimedia data, electronic documents located on the phishing resource, hyperlinks located on the phishing resource, scripts, and texts located on the phishing resource.

In some aspects, the techniques described herein relate to a method, wherein updating comprises disabling, in the database, a record about the phishing resource determined to be non-phishing.

In some aspects, the techniques described herein relate to a system for updating a database including information about phishing resources, including: at least one memory; and at least one hardware processor coupled with the at least one memory and configured, individually or in combination, to execute: a temporal model forming module configured to generate a temporal model for a phishing resource from the database; an evaluation module configured to: evaluate the phishing resource based on the temporal model; and determine that the phishing resource is non-phishing based on evaluation results generated during the evaluating; an updating module configured to update information about the phishing resource in the database.

In some aspects, the techniques described herein relate to a non-transitory computer readable medium storing thereon computer executable instructions for updating a database including information about phishing resources, including instructions for: generating a temporal model for a phishing resource from the database; evaluating the phishing resource based on the temporal model; determining that the phishing resource is non-phishing based on evaluation results generated during the evaluating; and updating information about the phishing resource in the database.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates an example of a computer network in which a system is implemented for updating a database including information about phishing resources.

FIG. 2 illustrates examples of the operation of a system for updating a database including information about phishing resources.

FIG. 3 shows a method for updating a database including information about phishing resources.

FIG. 4 presents an example of a general-purpose computer system on which aspects of the present disclosure can be implemented.

### DETAILED DESCRIPTION

The objects and features of the present disclosure, and methods for achieving these objects and features, may become apparent by reference to exemplary aspects. However, the present disclosure is not limited to the exemplary aspects disclosed below and may be embodied in various forms. The description provided is intended to assist a person skilled in the art in fully understanding the disclosure, which is defined solely by the scope of the appended claims.

The concepts and terms necessary to understand the claimed technical solution are described below. A resource may be a collection of interrelated web pages or a single web page hosted on the Internet. A previously adopted decision about a phishing resource may be a verdict previously rendered by an anti-phishing system indicating that the resource is phishing. An anti-phishing database may be a database including information about phishing resources, such as a web address.

The disclosure described herein addresses the problem of updating anti-phishing databases by evaluating phishing resources from the anti-phishing database. To optimize computational resources, the evaluation of phishing resources may be implemented according to a “lifetime” model of a phishing resource. According to the “lifetime” model of a phishing resource, phishing content may be removed from the resource or the web address of the resource may cease to be active with a higher probability in the first hours of the phishing resource's existence.

Accordingly, the record corresponding to such resources in the anti-phishing database becomes outdated, which in turn leads to false positives by the anti-phishing system. As one example, consider the compromise of a banking organization's resource. Administrators of a banking organization often respond quickly to such threats and promptly remove phishing content from the resource to ensure the security of users'confidential data and minimize reputational losses. However, it is highly likely that while the phishing content was present on the banking organization's resource, the anti-phishing system detected the phishing content on that resource and added a record about the banking organization's resource to the anti-phishing database. As a result, even after the phishing content is removed from the resource, the user will be unable to access the banking organization's resource.

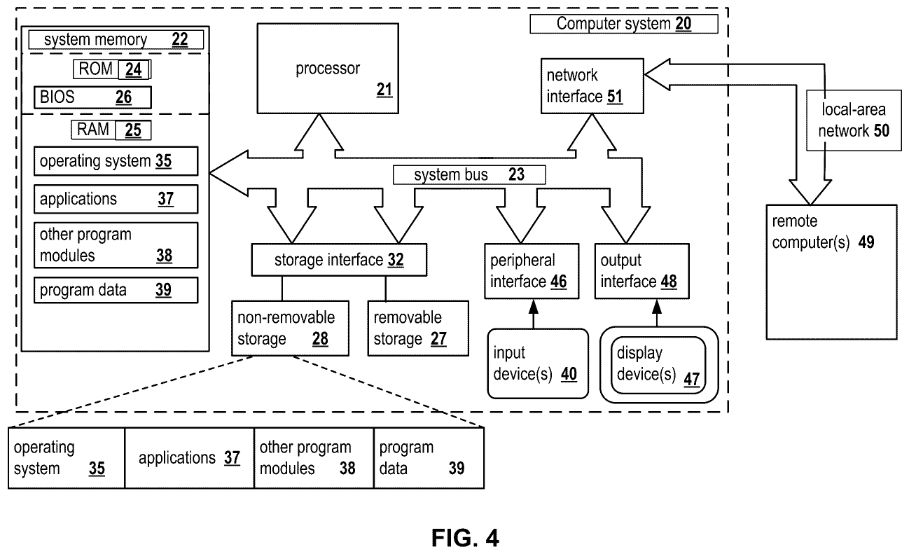

Such records about resources must be removed from clients' 160 anti-phishing databases in order to reduce false positives of the anti-phishing system and to reduce the amount of memory required to store the anti-phishing database on the client. In the claimed invention, a client is understood to be a computer system, for example, a system as presented in the description of FIG. 4. Using the “lifetime” model of a phishing resource makes it possible to achieve a balance between the frequency of evaluating phishing resources and the computational costs of evaluating phishing resources and updating the anti-phishing database.

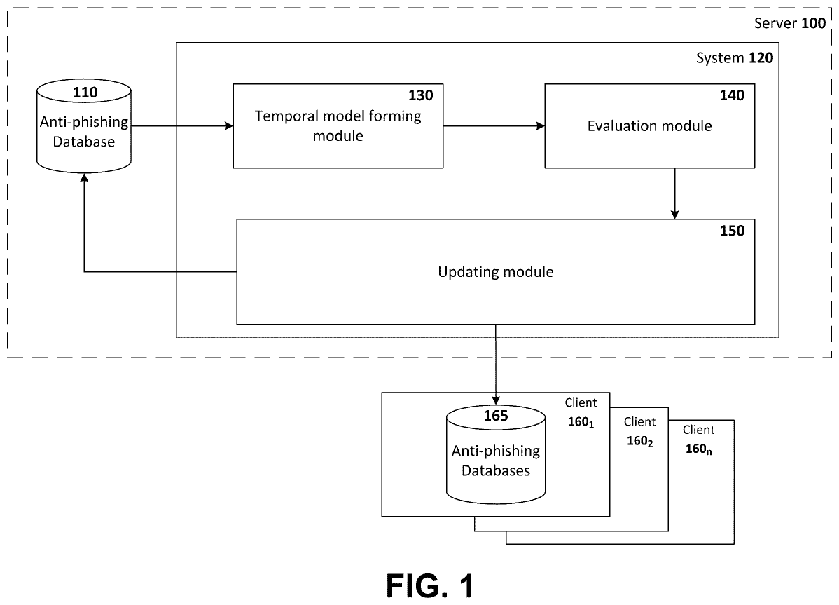

FIG. 1 illustrates an example of a computer network in which a system 120 for updating a database including information about phishing resources is implemented. The server 100 includes an anti-phishing database 110, the system 120, and an updating module 150.

The anti-phishing database 110 includes at least the following information about phishing resources:
a web address pointing to the phishing resource;
the date the record about the phishing resource was added to the anti-phishing database 110;
the status of the record about the phishing resource, for example, enabled/disabled.

In a preferred aspect, the date the record about the phishing resource was added to the anti-phishing database 110 is specified with an accuracy of up to one hour, for example “2024-10-28-15” (15:00 on Oct. 28, 2024). In particular aspects, the date the record about the phishing resource was added to the anti-phishing database 110 may be specified with greater accuracy, for example to minutes or seconds, or with less accuracy, for example to days.

The status of the record about the phishing resource in the anti-phishing database 110 indicates whether the given record should be included in the clients' anti-phishing databases 165 located on clients 160₁, 160₂ . . . 160ₙ (hereinafter, clients' 160 anti-phishing databases). If the status of the record about the phishing resource in the anti-phishing database 110 is “enabled” and it is not present in the clients' 160 anti-phishing databases, this record must be transmitted to the clients' 160 anti-phishing databases. If the status of the record about the phishing resource in the anti-phishing database 110 is “disabled” and it is present in the clients' 160 anti-phishing databases, this record must be deleted from the clients'160 anti-phishing databases.

For all resources whose records are stored in the anti-phishing database 110, a decision was previously made that the given resource is phishing. The decision about the presence of phishing content on a resource could have been made using any technical solution known from the prior art aimed at detecting phishing resources. Within the scope of this description, updating the previously adopted decision about a phishing resource is understood to mean a decision, based on evaluation of the phishing resource, that the resource no longer has phishing content or the resource is unavailable. Evaluation of a phishing resource is disclosed below.

The system 120 is designed to update the previously adopted decision about a phishing resource. The system 120 includes a temporal model forming module 130, an evaluation module 140, and an updating module 150. In a particular aspect, the system 120 additionally includes the anti-phishing database 110, which stores information about at least one phishing resource.

The temporal model forming module 130 is designed to form a temporal model for a phishing resource from the anti-phishing database 110. The temporal model reflects the schedule for evaluating the phishing resource and is based on the aforementioned “lifetime” model of a phishing resource. The temporal model includes evaluation phases and evaluation periods. The evaluation period is a time interval after which the phishing resource must be evaluated. The evaluation period is calculated for each evaluation phase based on the ordinal number of the evaluation phase and a phase coefficient. An evaluation phase is a predefined time interval, for example a week or a month. The phase coefficient is a predefined number.

Temporal model forming module 130 may be a software module or process that generates and manages temporal models for resource evaluation scheduling.

In a particular aspect, the temporal model additionally includes a trust counter. The trust counter reflects the level of trust in the resource and changes depending on the evaluations performed on the resource. The trust counter is initially equal to zero. Using a trust counter makes it possible to correctly evaluate “flapping” phishing resources. “Flapping” phishing resources are those that periodically become unavailable or from which phishing content is periodically removed. Attackers undertake such actions to whitewash their resources. Thus, a single determination that a resource is non-phishing is insufficient for a correct evaluation of the resource. An example implementation of a temporal model including a trust counter is described in detail below.

In a particular aspect, the evaluation period equals the product of the ordinal number of the evaluation phase and the phase coefficient. For example, if the phase coefficient is 48 hours, then the evaluation period for the first evaluation phase is 48 hours, for the second evaluation phase it is 96 hours, and so on. In yet another particular aspect, the temporal model is presented as a mathematical model: t mod ([(l div F)+1]*k)=0, where t is the time in hours from the start of initialization of the evaluation of phishing resources from the anti-phishing database 110, l is the time in hours elapsed since the record about the phishing resource was added to the anti-phishing database 110, F is the evaluation phase in hours, and k is the phase coefficient. If the expression “t mod ([(l div F)+1]*k)” equals zero, the corresponding resource must be evaluated.

Thus, according to the temporal model, in the first F hours (the first evaluation phase) the phishing resource will be evaluated every k hours, in the next F hours (the second evaluation phase) every 2k hours, in the following F hours (the third evaluation phase) every 3k hours, and so on. For the first, second, and third evaluation phases, the evaluation period equals k, 2k, and 3k, respectively. The temporal model forming module 130 may form a temporal model for each phishing resource from the anti-phishing database 110. The temporal model forming module 130 may calculate the evaluation phases for each phishing resource by finding the difference between the time the temporal model is created and the time the record about the phishing resource was added to the anti-phishing database 110.

For example, if the evaluation phase equals seven days and the temporal model forming module 130 forms the temporal model on 2024-10-28, then the first evaluation phase will end on 2024-11-04, the second evaluation phase will end on 2024-11-11, and so on. In a preferred aspect, the evaluation phase and evaluation period are specified in hours. However, as seen from the example above, the evaluation phase and evaluation period can be specified with other precision, for example in days or minutes. The temporal model forming module 130 sends all created temporal models to the evaluation module 140.

The evaluation module 140 is designed to evaluate phishing resources based on the temporal models received from the temporal model forming module 130 and to update the previously adopted decision about phishing resources from the anti-phishing database 110. The evaluation module 140 may evaluate phishing resources, and the evaluation may be implemented by any method known from the prior art. In a preferred aspect, evaluation of phishing resources may be implemented using a machine learning model intended to solve the task of classifying resources into two classes, namely phishing resources and non-phishing resources.

Evaluation module 140 may be a software component or module that performs automated analysis and classification of resources using machine learning algorithms such as: logistic regression (LR), decision tree (DT), random forest (RF), support vector machine (SVM), k-nearest neighbors (KNN), naive Bayes, and linear discriminant analysis (LDA).

Classification using a machine learning model is implemented based on content information and/or meta-information about the resource. The content information includes at least one of: HTML code of the web page; Flash applications or Java applets loaded from the web page; multimedia data (for example, images included on the web page); electronic documents located on the web page (Microsoft Office documents, PDF, etc.); hyperlinks located on the web page; scripts (for example, JavaScript or VBA); texts located on the web page.

The meta-information includes at least one of: information from a service intended to obtain WHOIS information; position in an Internet resource ranking (for example, AlexaRank).

In a particular aspect, evaluation of a phishing resource is implemented based on analysis of the resource's HTML code, with the resource's HTML code being converted into a tree. The tree represents a set of connected nodes, represented by the resource's web pages. Based on the evaluation results, the resource is recognized as a phishing resource if at least one web page in the resource's tree is determined to be phishing.

In a particular aspect in which the temporal model additionally includes a trust counter, if the trust counter becomes equal to a predefined threshold value, for example three, the evaluation module 140 will determine the corresponding resource to be non-phishing.

The evaluation module 140 evaluates each phishing resource from the anti-phishing database 110 in accordance with the temporal model. If the evaluation result shows that the resource is non-phishing, the evaluation module 140 increments the trust counter by one. If the trust counter is not zero, the evaluation module 140 performs the next evaluation after a predefined fixed time interval, for example one hour. Thus, the evaluation module 140 will evaluate the phishing resource until the trust counter equals the threshold value. If during an evaluation performed based on the specified fixed time interval the trust counter is not zero and is less than the threshold value, and the result of that evaluation shows that the resource is phishing, the trust counter is reset (set to zero). If the trust counter equals the threshold value, the evaluation module 140 updates the previously adopted decision about the resource and sends the updated decision regarding the need to change the record about the resource to the updating module 150.

In another particular aspect, the anti-phishing database 110 additionally includes the hash of the web page based on which the resource was recognized as phishing. In this case, before evaluating the resource itself, the evaluation module 140 checks for changes to the web page whose hash is stored in the anti-phishing database 110, based on comparing hashes. If the hashes do not match, this means that the web page has changed. In that case, the evaluation module 140 evaluates the resource. Otherwise, if the web page has not changed, no further evaluation is performed and the result of the previous evaluation remains.

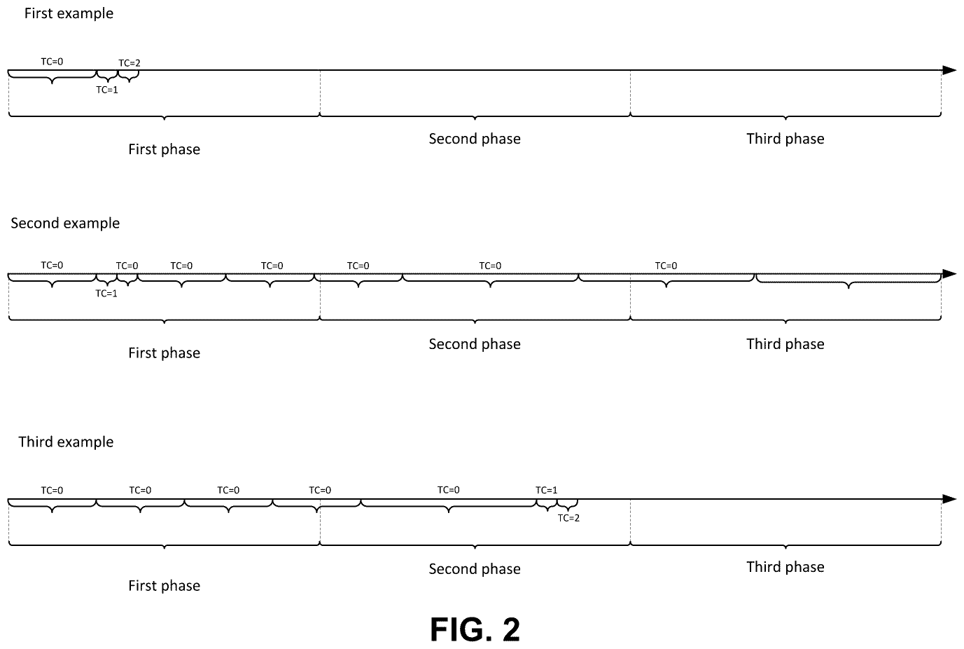

To better understand the operation of the evaluation module 140, consider several examples. FIG. 2 illustrates examples of the operation of the database updating system 120. In FIG. 2, TC denotes the trust counter. Assume that the record about a phishing resource was added at 12:00 am. on Nov. 1, 2024(2024 -11-01-12) to the anti-phishing database 110. At that moment, the temporal model was created on 2024-11-01-12, according to which the phishing resource is evaluated. The evaluation phase equals 168 hours, the evaluation period equals 48 hours, the threshold value of the trust counter equals 2, and evaluation when the trust counter is nonzero is performed every hour.

First example. The evaluation module 140 evaluates the phishing resource according to the temporal model on 2024-11-03-12 (48 hours after the record about the phishing resource was added to the anti-phishing database 110). The evaluation result showed that the resource is non-phishing. The evaluation module 140 increments the trust counter by one. The trust counter does not equal the threshold value, therefore the evaluation module 140 evaluates the phishing resource on 2024-11-03-13 (one hour after the last evaluation). The result of the evaluation showed that the resource is non-phishing. The evaluation module 140 increments the trust counter by one. The trust counter equals the threshold value (two). The evaluation module 140 makes the final decision that the resource is non-phishing and sends information about the need to change the previously adopted decision (the status of the record) about the resource stored in the anti-phishing database 110 to the updating module 150.

Second example. The evaluation module 140 creates a trust counter equal to zero and evaluates the phishing resource according to the temporal model on 2024-11-03-12 (48 hours after the phishing resource was added to the anti-phishing database 110). The evaluation result showed that the resource is non-phishing. The evaluation module 140 increments the trust counter by one. The trust counter does not equal the threshold value, therefore the evaluation module 140 evaluates the phishing resource on 2024-11-03-13 (one hour after the last evaluation). The result of the evaluation showed that the resource is phishing. The evaluation module 140 resets the trust counter of the given resource and continues evaluation according to the temporal model. At the same time, the information in the anti-phishing database 110 remains unchanged for this record.

Third example. The evaluation module 140 creates a trust counter equal to zero and evaluates the phishing resource according to the temporal model on 2024-11-03-12 (48 hours after the record about the phishing resource was added to the anti-phishing database 110). The evaluation result showed that the resource is phishing. The evaluation module 140 evaluates the phishing resource according to the temporal model on 2024-11-05-12 (48 hours after the last evaluation). The evaluation result showed that the resource is phishing. The evaluation module 140 evaluates the phishing resource according to the temporal model on 2024-11-07-12 (48 hours after the last evaluation). The evaluation result showed that the resource is phishing. The evaluation module 140 evaluates the phishing resource according to the temporal model on 2024-11-09-12 (48 hours after the last evaluation). The evaluation result showed that the resource is phishing. At this point, according to the temporal model, the second phase begins, since more than 168 hours have passed since the record about the phishing resource was added to the anti-phishing database 110. The evaluation module 140 evaluates the phishing resource according to the temporal model on 2024-11-13-12. The evaluation result showed that the resource is non-phishing. The evaluation module 140 increments the trust counter by one. The trust counter does not equal the threshold value, therefore the evaluation module 140 evaluates the phishing resource on 2024-11-13-13 (one hour after the last evaluation). The evaluation result showed that the resource is non-phishing. The evaluation module 140 increments the trust counter by one. The trust counter equals the threshold value (two). The evaluation module 140 makes the final decision that the resource is non-phishing and sends information about the need to change the previously adopted decision (the status of the record) about the resource stored in the anti-phishing database 110 to the updating module 150.

The updating module 150 may be designed to update the anti-phishing database 110 and the clients' 160 anti-phishing databases. The updating module 150 may receive the updated decision about phishing resources from the evaluation module 140. The updating module 150 may disable the records about phishing resources in the anti-phishing database 110 for which the previously adopted decision was updated. The updating module 150 may delete the records about phishing resources from the clients'160 anti-phishing databases for which the previously adopted decision was updated. In a particular aspect, the updating module 150 may delete records about phishing resources from the anti-phishing database 110.

Updating module 150 may be a software process or service that manages the modification and synchronization of database records based on evaluation outcomes.

Thus, by disabling records that do not relate to phishing resources through the use of the system 120 for updating the previously adopted decision about a phishing resource, the technical result may be achieved of reducing false positives of the anti-phishing system. It should also be noted that by reducing the number of evaluations for each phishing resource whose record is stored in said database, a second technical result may be achieved, namely increasing the efficiency of updating the anti-phishing database 110 including information about phishing resources.

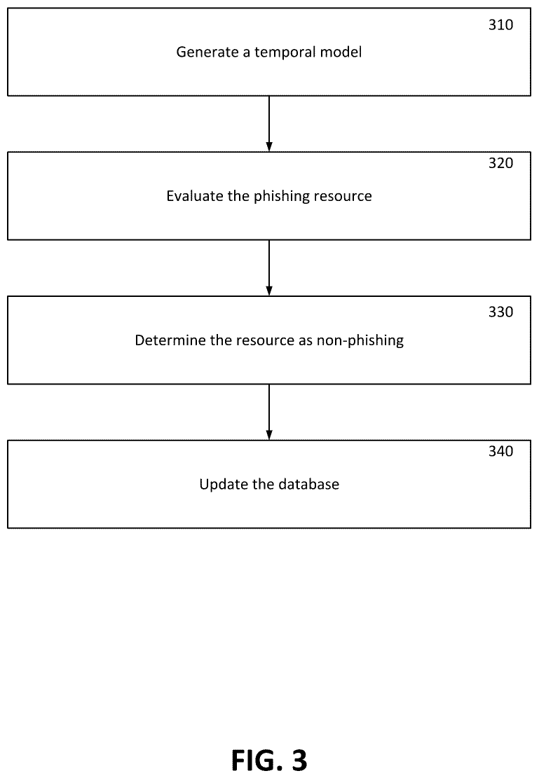

FIG. 3 shows a method for updating a database including information about phishing resources.

At step 310, a temporal model is formed (used interchangeably with “generated”) for each phishing resource from the database. In a preferred aspect, the formed temporal model includes an evaluation phase and an evaluation period. The evaluation period is calculated for each evaluation phase based on the ordinal number of the evaluation phase and a phase coefficient, where the phase coefficient is a predefined number. In a particular aspect, the formed temporal model additionally includes a trust counter, initially equal to zero and incremented each time the phishing resource is determined to be non-phishing based on the evaluation results.

In a preferred aspect, the database includes at least the following information about phishing resources: a web address pointing to the phishing resource; the date the record about the phishing resource was added; the status of the record about the phishing resource. In a particular aspect, the database additionally includes the hash of the phishing resource's web page.

At step 320, the phishing resource is evaluated according to the formed temporal model. In a particular aspect, before evaluating the resource itself, a check for changes to the web page is performed based on comparing hashes. In a preferred aspect, the phishing resource is evaluated using a machine learning model intended to solve the task of classifying resources into two classes, namely phishing resources and non-phishing resources. Classification using a machine learning model is implemented based on content information and/or meta-information about the resource.

In a particular aspect, one of the following is used as the machine learning model: logistic regression, decision tree, random forest, support vector machines, k-nearest neighbors, naive Bayes, and linear discriminant analysis.

In a preferred aspect, the content information includes at least one of: the resource's HTML code; Flash applications or Java applets loaded from the resource; multimedia data (for example, images included on the web page); electronic documents located on the resource (Microsoft Office documents, PDF, etc.); hyperlinks located on the resource; scripts (for example, JavaScript or VBA); texts located on the resource. The meta-information includes at least one of: information from a service intended to obtain WHOIS information; position in an Internet resource ranking (for example, AlexaRank).

At step 330, the phishing resource is determined to be non-phishing based on the evaluation results.

At step 340, the database is updated, namely the information about the phishing resource in said database. In a particular aspect, the database is updated, namely the information about the phishing resource from said database, when the trust counter equals a threshold value, where the threshold value is a predefined integer. In a particular aspect, to update the database, the record about a resource determined to be non-phishing is deleted.

A method for updating a database that includes information about phishing resources may involve several key steps to ensure the accuracy and relevance of the stored data. First, the method may begin by generating a temporal model for a phishing resource that is already present in the database. For example, if a suspicious website has been flagged and added to the database, the system may create a temporal model that outlines when and how often this resource should be re-evaluated. This model serves as a schedule or framework for ongoing assessment, ensuring that the resource is not simply left in the database indefinitely without further scrutiny.

The next step involves evaluating the phishing resource based on the temporal model. This means that, according to the schedule set by the model, the system will periodically analyze the resource to determine whether it still poses a phishing threat. For instance, if the model specifies that the resource should be checked every 48 hours, the system will automatically perform an evaluation at those intervals. The evaluation may include various checks, such as content analysis or comparison with known phishing patterns.

Based on the results of these evaluations, the system may determine that the phishing resource is no longer a threat. For example, if the content of the website has changed and no longer contains phishing elements, or if the site is no longer accessible, the system may conclude that the resource is non-phishing. This determination is crucial for maintaining the accuracy of the database and preventing false positives that could block legitimate sites.

Once a resource is determined to be non-phishing, the method may update the information about the resource in the database. This update could involve changing the status of the record, removing the resource from active monitoring, or even deleting the record entirely, depending on the system's configuration and policies.

The temporal model itself may include an evaluation phase and an evaluation period. The evaluation phase refers to a specific time window during which evaluations are conducted, while the evaluation period defines how frequently these evaluations occur within that phase. For example, the first phase might involve daily checks for the first week, followed by weekly checks in subsequent phases.

The evaluation period for each phase may be calculated based on the ordinal number of the phase and a phase coefficient, which is a predefined number. For instance, if the phase coefficient is set to 48 hours, the first phase might have evaluations every 48 hours, the second phase every 96 hours, and so on, allowing the system to gradually reduce the frequency of checks as the resource remains unchanged.

Additionally, the temporal model may include a trust counter, which is initially set to zero. Each time the resource is evaluated and determined to be non-phishing, the trust counter is incremented. This mechanism helps to prevent premature removal of resources that may intermittently appear safe. For example, if a phishing site temporarily removes malicious content to evade detection, the trust counter ensures that only consistently safe resources are eventually cleared.

The information about the phishing resource in the database may be updated when the trust counter reaches a threshold value, which is a predefined integer. For example, if the threshold is set to three, the resource must be found non-phishing in three consecutive evaluations before its status is updated or it is removed from the database.

The database may store various types of information about each phishing resource, such as the web address, the date the record was added, and the current status of the record (e.g., active, disabled, or under review). In some implementations, the database may also include a hash of the web page associated with the phishing resource. This hash serves as a fingerprint of the page's content at the time it was flagged.

When evaluating the phishing resource, the system may check for changes to the web page by comparing the current hash with the stored hash. If the hashes differ, it indicates that the page content has changed, prompting a more detailed evaluation to determine if the resource is still a threat.

The evaluation process may leverage a machine learning model trained to solve a classification task based on content information and/or meta-information about the phishing resource. For example, the model may analyze the HTML code, embedded scripts, or other features of the web page to classify it as phishing or non-phishing. The machine learning model could be any of several types, such as logistic regression, decision tree, random forest, support vector machines, k-nearest neighbors, naive Bayes, or linear discriminant analysis, depending on the complexity and requirements of the system.

Content information used in the evaluation may include the HTML code of the phishing resource, Flash applications or Java applets loaded from the resource, multimedia data (such as images or videos), electronic documents (like PDFs or Word files), hyperlinks, scripts, and any text present on the resource. Meta-information may include data obtained from WHOIS services (such as domain registration details) or the resource's position in an Internet ranking system (like Alexa Rank), which can provide additional context for the evaluation.

Finally, updating the database may involve disabling the record about the phishing resource if it is determined to be non-phishing. For example, the system may mark the record as inactive or remove it from the list of active threats, ensuring that users are not unnecessarily blocked from accessing legitimate resources that were previously misclassified. This comprehensive approach helps maintain the accuracy and efficiency of anti-phishing systems while minimizing false positives and resource consumption.

FIG. 4 is a block diagram illustrating a computer system 20 on which aspects of systems and methods for updating a database including information about phishing resources may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-3 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some aspects, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for updating a database including information about phishing resources, comprising:
generating a temporal model for a phishing resource from the database;
evaluating the phishing resource based on the temporal model;
determining that the phishing resource is non-phishing based on evaluation results generated during the evaluating; and
updating information about the phishing resource in the database.

2. The method of claim 1, wherein the temporal model includes an evaluation phase and an evaluation period.

3. The method of claim 2, wherein the evaluation period is calculated for each evaluation phase based on an ordinal number of the evaluation phase and a phase coefficient, wherein the phase coefficient is a predefined number.

4. The method of claim 2, wherein the temporal model additionally includes a trust counter, initially equal to zero and incremented each time the phishing resource is determined to be non-phishing based on the evaluation results.

5. The method of claim 4, wherein the information about the phishing resource is updated in the database when the trust counter equals a threshold value, wherein the threshold value is a predefined integer.

6. The method of claim 1, wherein the information about the phishing resource further includes one or more of: a web address pointing to the phishing resource; a date a record about the phishing resource was added to the database; and a status of the record about the phishing resource.

7. The method of claim 6, wherein the information about the phishing resource additionally includes a hash of a web page of the phishing resource.

8. The method of claim 7, wherein evaluating the phishing resource includes checking for changes to the web page based on comparing hashes.

9. The method of claim 1, wherein evaluating the phishing resource is carried out according to the temporal model based on at least one of:
a machine learning model trained to solve a classification task based on content information and/or meta information about the phishing resource;
analysis of HTML code of the phishing resource converted into a tree.

10. The method of claim 9, wherein the content information about the phishing resource is at least one of: the HTML code of the phishing resource; Flash applications or Java applets loaded from the phishing resource, multimedia data, electronic documents located on the phishing resource, hyperlinks located on the phishing resource, scripts, and texts located on the phishing resource.

11. The method of claim 1, wherein updating comprises disabling, in the database, a record about the phishing resource determined to be non-phishing.

12. A system for updating a database including information about phishing resources, including:
at least one memory; and
at least one hardware processor coupled with the at least one memory and configured, individually or in combination, to execute:
a temporal model forming module configured to generate a temporal model for a phishing resource from the database;
an evaluation module configured to:
evaluate the phishing resource based on the temporal model; and
determine that the phishing resource is non-phishing based on evaluation results generated during the evaluating;
an updating module configured to update information about the phishing resource in the database.

13. The system of claim 12, wherein the temporal model generated by the temporal model forming module includes an evaluation phase and an evaluation period.

14. The system of claim 13, wherein the evaluation period is calculated for each evaluation phase based on an ordinal number of the evaluation phase and a phase coefficient, wherein the phase coefficient is a predefined number.

15. The system of claim 13, wherein the temporal model generated by the temporal model forming module additionally includes a trust counter, initially equal to zero and incremented each time the phishing resource is determined to be non-phishing based on the evaluation results.

16. The system of claim 15, wherein the information about the phishing resource is updated by the updating module in the database when the trust counter equals a threshold value, wherein the threshold value is a predefined integer.

17. The system of claim 12, wherein the information about the phishing resource further includes one or more of: a web address pointing to the phishing resource; a date a record about the phishing resource was added to the database; and a status of the record about the phishing resource.

18. The system of claim 12, wherein the evaluating module evaluates the phishing resource according to the temporal model based on at least one of:
a machine learning model trained to solve a classification task based on content information and/or meta information about the phishing resource; and
analysis of HTML code of the phishing resource converted into a tree.

19. The system of claim 12, wherein the updating module updates the database by disabling the record about a resource determined to be non-phishing.

20. A non-transitory computer readable medium storing thereon computer executable instructions for updating a database including information about phishing resources, including instructions for:
generating a temporal model for a phishing resource from the database;
evaluating the phishing resource based on the temporal model;
determining that the phishing resource is non-phishing based on evaluation results generated during the evaluating; and
updating information about the phishing resource in the database.
